(19) United States
(12) Patent Application Publication
(10) Pub. No.: US 2026/0063210 A1
(43) Pub. Date: Mar. 5, 2026

(54) FLUID CONNECTOR

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: HSIU-YUAN HSU, New Taipei (TW); MING-YUE CHEN, New Taipei (TW); YAO-CHI HUANG, New Taipei (TW); WEN HE, Kunshan (CN); LING-XIAONG LI, Shenzhen (CN); LING TAO, Shenzhen (CN)

(21) Appl. No.: 19/314,680

(22) Filed: Aug. 29, 2025

(30) Foreign Application Priority Data
Aug. 30, 2024 (CN) 202411209986.3

(51) Int. Cl. F16K 5/06; F16K 27/06; F16K 31/60; F16K 35/06

(52) U.S. Cl. CPC F16K 5/0647; F16K 27/06; F16K 35/06; F16K 31/602

(57) ABSTRACT

A fluid connector includes a shell having a fluid channel, a ball valve accommodated in the shell and having a through hole, a control element arranged outside the shell for controlling the ball valve to rotate, and a pin member. A front end of the shell for engaging a matching connector has an engagement hole. The control element controls the ball valve between a closed position and an open position. The through hole is in fluid communication with the fluid channel when the ball valve is at the open position. A front face of the shell has an accommodating hole for accommodating the pin member. A resilient member is arranged in the accommodating hole for supporting the pin member. The pin member obstructs the rotation of the control element unless it is in a set position.

### BACKGROUND OF THE INVENTION

### Field of the Invention

The present invention relates to a fluid connector, particularly to a fluid connector preventing leakage which has a simple structure and is easy to manufacture.

### Description of Related Arts

U.S. Pat. No. 8,132,781 discloses a fluid connector including a shell, a ball valve accommodated in the shell, a handle arranged outside the shell for controlling the ball valve, a detecting pin protruding from a front face of the shell under a normal state, and a locking pin for engaging an engagement hole of a matching fluid connector. The handle can drive the locking pin to extend out of the front face of the shell. The detecting pin can control whether the locking pin and the handle can be linked through a locking member, e.g., a roller element. However, the fluid connector has many components and a complicated structure. China Patent Application Publication No. 117052931 discloses an improvement to such a fluid connector wherein a corresponding handle directly interacts with a corresponding roller element.

### SUMMARY OF THE INVENTION

A fluid connector includes a shell having a fluid channel, a ball valve accommodated in the shell and having a through hole, a control element arranged outside the shell for controlling the ball valve to rotate, and a pin member. A front end of the shell for engaging a matching connector has an engagement hole. The control element controls the ball valve between a closed position and an open position. The through hole is in fluid communication with the fluid channel when the ball valve is at the open position. A front face of the shell has an accommodating hole for accommodating the pin member. A resilient member is arranged in the accommodating hole for supporting the pin member. The pin member is resiliently supported by the resilient member and positioned at a first position extending out of the accommodating hole when the fluid connector is free of engagement to a matching connector. When the fluid connector abuts the matching connector, the pin member presses the resilient member and retracts to a second position in the accommodating hole. When the fluid connector abuts the matching connector and is rotated such that the pin member corresponds to an engagement hole of the matching connector, the pin member is pushed by the resilient member and is positioned at a third position extending into the engagement hole. The rear end of the pin member is accommodated in the control element, and when the pin member is positioned at the first position or at the second position, the rear end of the pin member prevents the control element from rotating the ball valve. When the pin member is positioned at the third position, the control element is free of restriction by the pin member and is able to control the ball valve to rotate.

### BRIEF DESCRIPTION OF DRAWINGS

FIG. 1 shows a perspective view of a fluid connector and a matching connector according to the present disclosure;

FIG. 2 shows a perspective view of a control element of the fluid connector at an unopened state according to the present disclosure;

FIG. 3 shows a perspective view of the fluid connector after abutting the matching connector according to the present disclosure;

FIG. 4 shows a perspective view of the control element of the fluid connector at an open state according to the present disclosure;

FIG. 5 shows an exploded view of the fluid connector according to the present disclosure;

FIG. 6 shows an exploded view of the fluid connector from the other perspective;

FIG. 7 shows an exploded view of the fluid connector from another perspective;

FIG. 8 shows a top view of the fluid connector according to the present disclosure;

FIG. 9 shows a cross-sectional view along cut line A-A of FIG. 2;

FIG. 10 shows a cross-sectional view along cut line B-B of FIG. 2;

FIG. 11 shows a cross-sectional view along cut line C-C of FIG. 2;

FIG. 12 shows a cross-sectional view of the fluid connector of FIG. 11 after being rotated such that a pin member thereof is inserted into an engagement hole of the matching connector;

FIG. 13 shows a cross-sectional view along cut line D-D of FIG. 4; and

FIG. 14 shows a cross-sectional view along cut line E-E of FIG. 4.

### DETAILED DESCRIPTION OF THE DRAWINGS

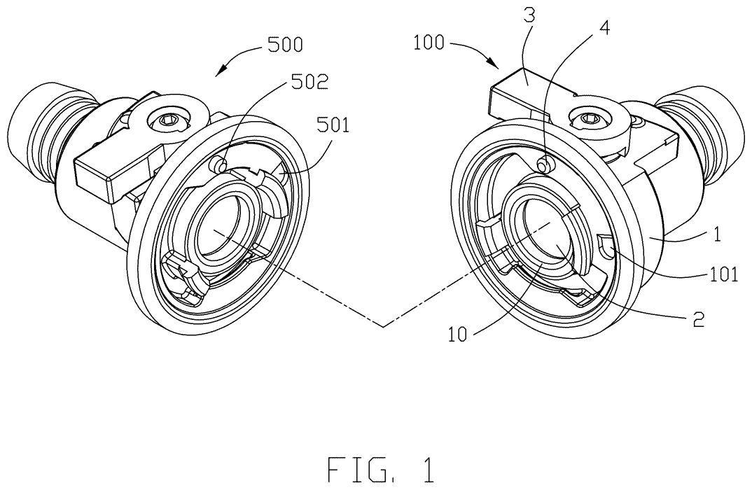

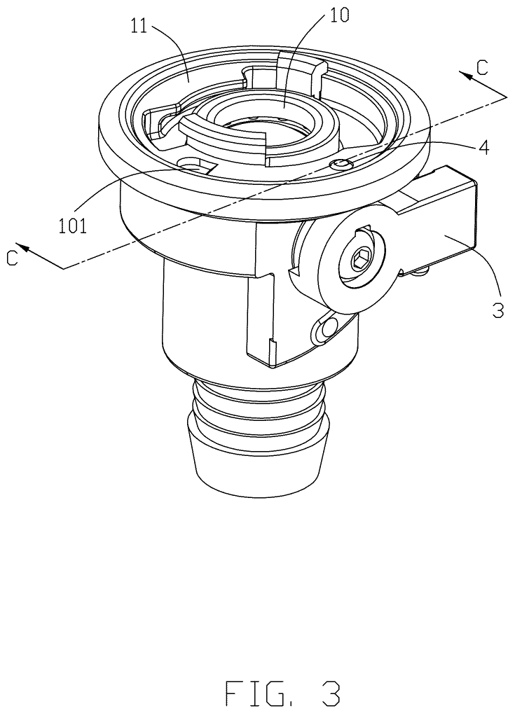

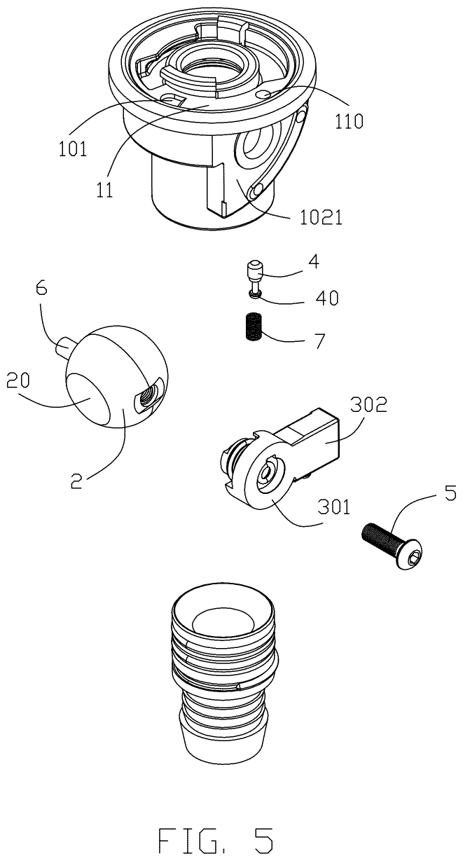

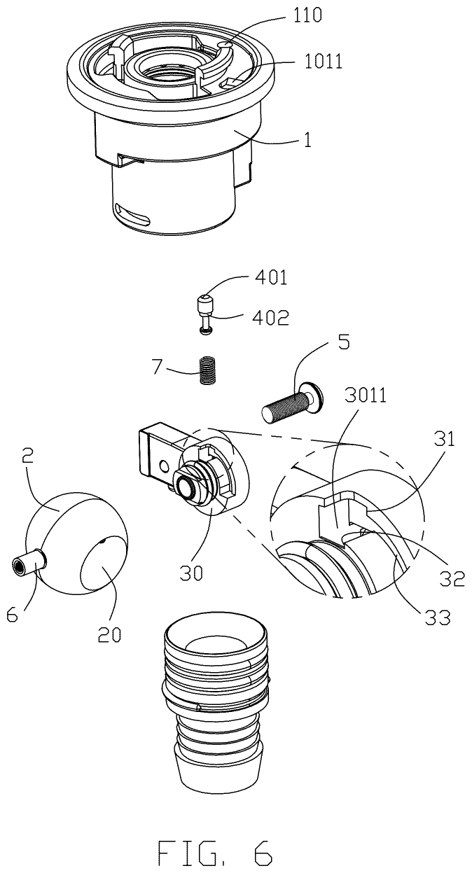

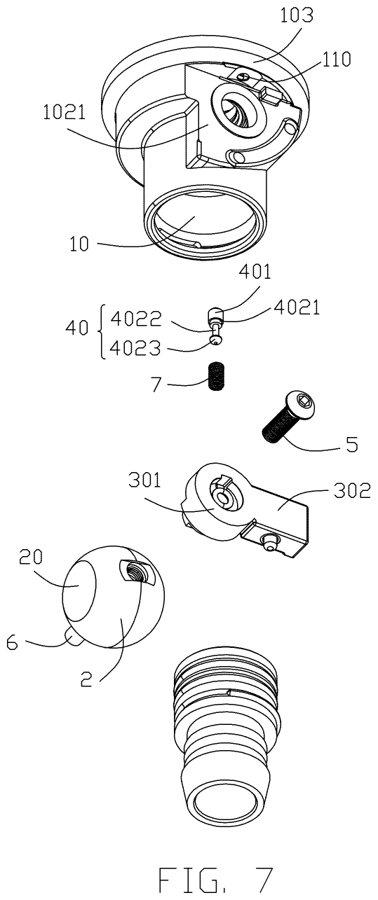

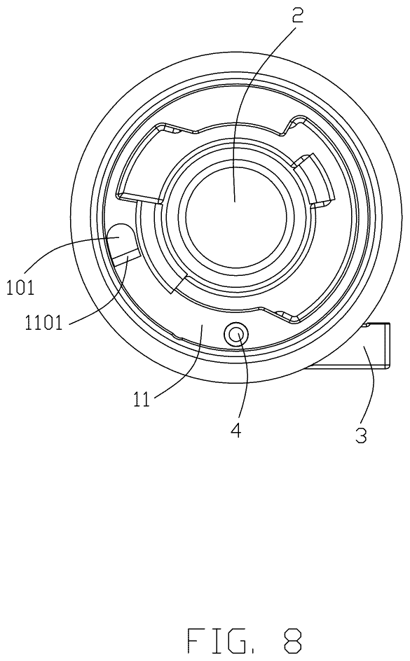

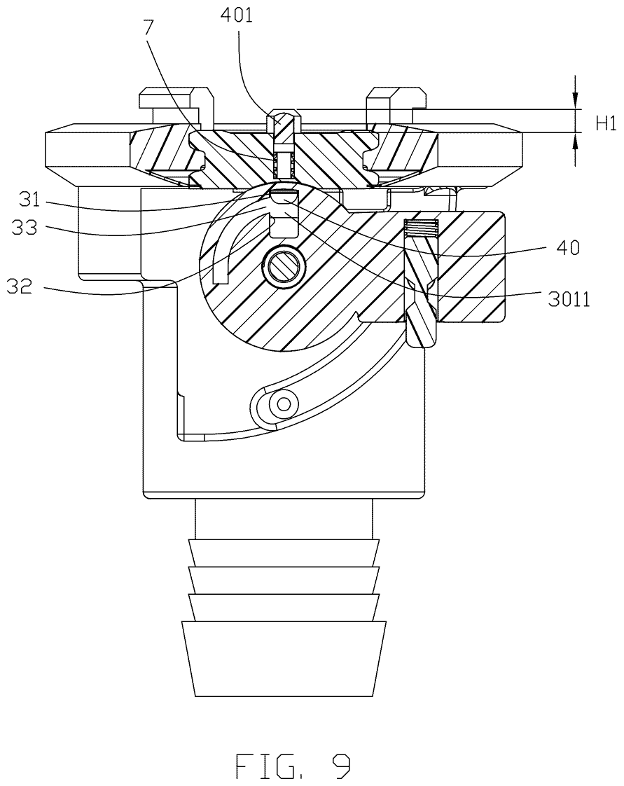

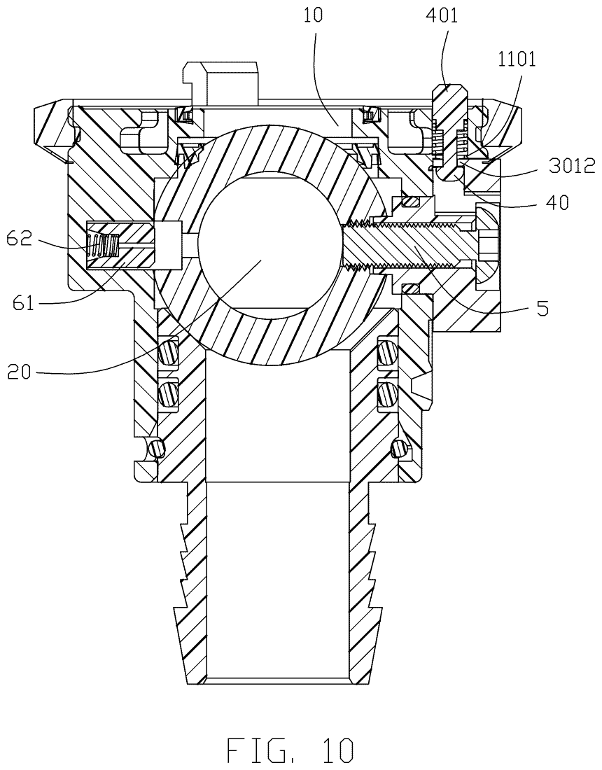

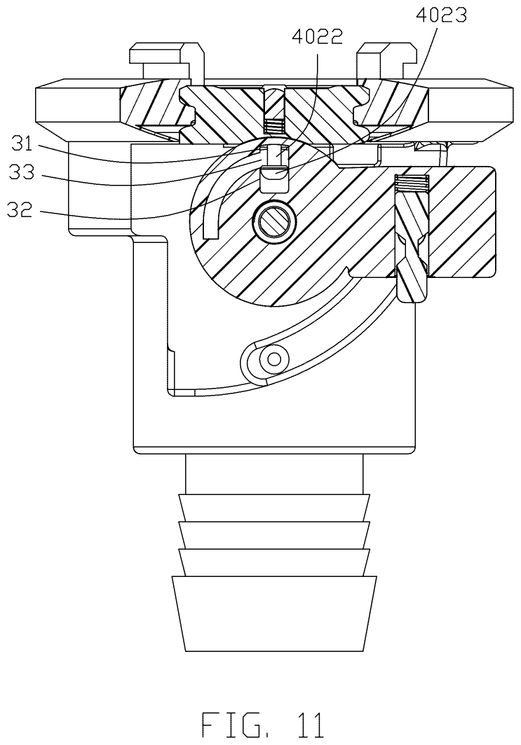

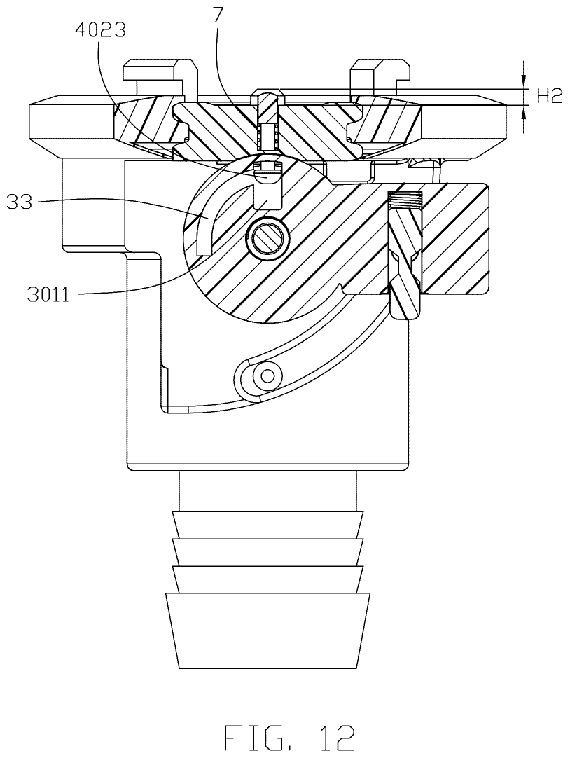

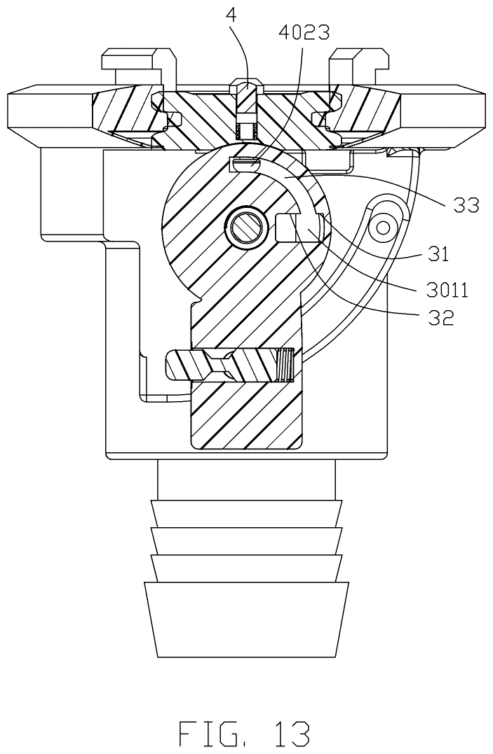

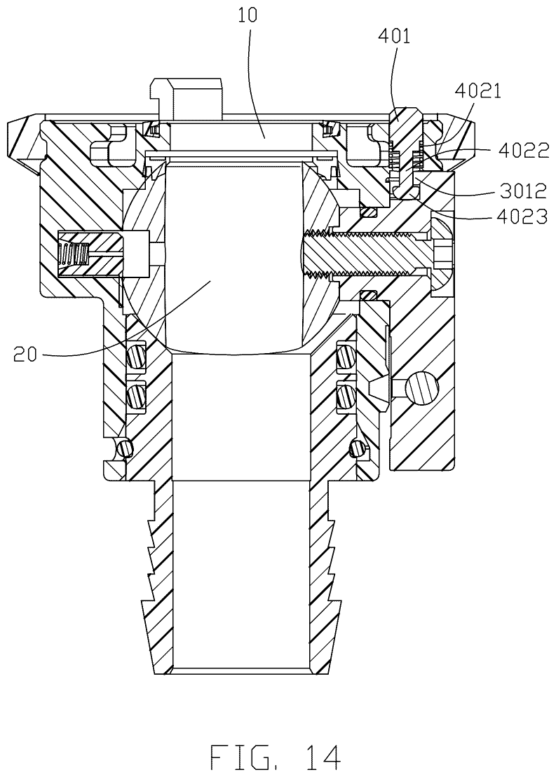

Referring to FIGS. 1-14, the present disclosure discloses a fluid connector 100, for connecting to a matching connector 500 such that the two connectors are in fluid communication with each other. The fluid connector 100 includes a shell 1 having a fluid channel 10, a ball valve 2 accommodated in the shell 1 and having a through hole 20, a control element 3 installed outside the shell 1 and connected to the ball valve 2 for controlling a rotation of the ball valve 2, and a pin member 4 protruding from a front face 11 of the shell 1 for engaging an engagement hole 501 arranged on a front end of the matching connector 500. The fluid connector 100 has a structure similar to that of the matching connector 500. The fluid connector 100, besides having the pin member 4, also has an engagement hole 101 arranged at a front end of the shell 1. The matching connector 500, besides having the engagement hole 501, also has a pin member 502. When the fluid connector 100 engages the matching connector 500 and rotates to position, the pin member 4 of the fluid connector 100 enters the engagement hole 501 of the matching connector 500, and the pin member 502 of the matching connector 500 enters the engagement hole 101 of the fluid connector 100, thereby realizing a locking function between the two connectors, effectively eliminating leakage.

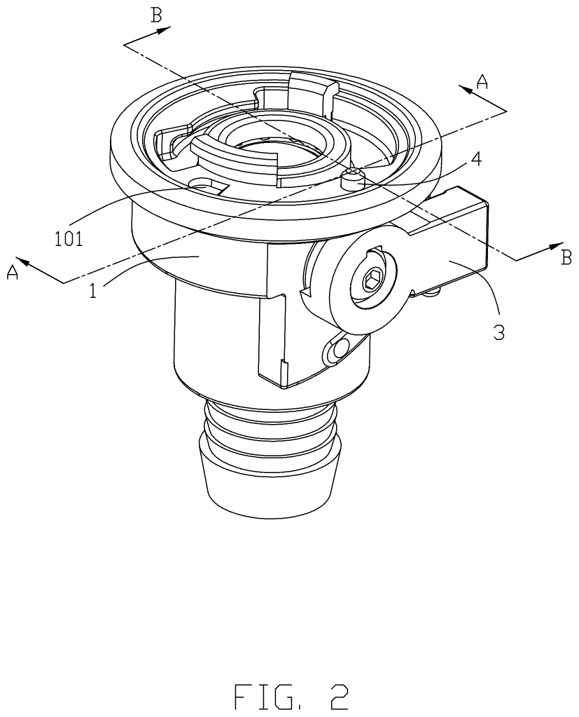

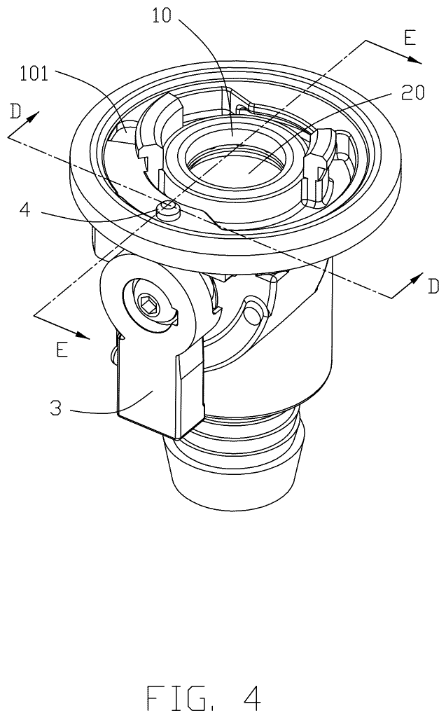

The control element 3 controls the ball valve 2 to rotate between a closed position for obstructing the fluid channel 10 and an open position for opening the fluid channel 10. Referring to FIGS. 2, 9, and 10, when the control element 3 is not rotated, the through hole 20 of the ball valve 2 is not in fluid communication with the fluid channel 10. In this situation, the ball valve 2 is at the closed position for obstructing the fluid channel 10. Referring to FIGS. 4, 13, and 14, after the control element 3 rotates, the through hole 20 of the ball valve 2 is in fluid communication with the fluid channel 10. In this situation, the ball valve 2 is at an open position for opening the fluid channel 10. In the present disclosure, the control element 3 is fixedly connected to the ball valve 2 through a post member 5, so as to drive the rotation of the ball valve 2. At an opposite side of the ball valve 2 corresponding to the post member 5, a pivot member 6 is arranged in the shell 1. The pivot member 6 includes a pivot portion 61 having one end fixed to the ball valve 2 and another end pivotally arranged to the shell 1, and a spring 62 arranged in the pivot portion 61 and supported at the shell 1. The spring 62 can allow the ball valve 2 to securely rotate.

The front face 11 of the shell 1 has an accommodating hole 110 for accommodating the pin member 4. A resilient member 7 for supporting the pin member 4 is arranged in the accommodating hole 110. When the fluid connector 100 is not engaged to the matching connector 500, the pin member 4 is supported by the resilient member 7 and is at a first position protruding from the accommodating hole 110. When the fluid connector 100 abuts the matching connector 500, the pin member 4 is pressed by the matching connector 500 and compresses the resilient member 7, and is at a second position retracted in the accommodating hole 110. When the fluid connector 100 abuts the matching connector 500 and is rotated until the pin member 4 engages the engagement hole 501 of the matching connector 500, the pin member 4 is pushed by the resilient member 7 and extends to a third position into the engagement hole 501. When the pin member 4 is positioned at the first position, the pin member 4 protrudes from the accommodating hole 110 by a first height H1. When the pin member 4 is positioned at the second position, the pin member 4 protrudes from the accommodating hole 110 by a second height H2 less than the first height H1. The pin member 4 extends rearwardly from the receiving hole 110 to form an extending portion 40 for insertion into the operating member 3, and when the pin member 4 is positioned at the first position or at the second position, the extending portion 40 restricts the control element 3 from rotating the ball valve 2. When the pin member 4 is positioned at the third position, the control element 3 is not restricted by the extending portion 40 and can rotate the ball valve 2. Additionally, when the pin member 4 is at the third position and uses a rotation of the control element 3 to rotate the ball valve 2 to the open position, the pin member 4 is restricted by the extending portion 40 and cannot retract into the accommodating hole 110. Thus, the ball valve 2 cannot be unlocked in the open state, thereby preventing improper controlling from resulting in a loss of fluid.

The side wall 102 of the shell 1 has a mounting surface 1021 for mounting the control element 3. The front end of the shell 1 has a protrusion 103 protruding from the mounting surface 1021, and the accommodating hole 110 extends through front and rear sides of the protrusion 103. A step 1101 is arranged in the accommodating hole 110 to support the resilient member 7, and the extending portion 40 extends rearward beyond the protrusion 103 to reach the area where the mounting surface 1021 is located. The extending portion 40 extends into the control element 3 to control the operation of the control element 3. The control element 3 has a first stopper 31, a second stopper 32 and a pass groove 33, and the pass groove 33 is located between the first stopper 31 and the second stopper 32 in a front-rear direction. When the pin member 4 is supported by the resilient member 7 and is at a first position protruding from the accommodating hole 110, the first stopper 31 abuts the extending portion 40, thereby restricting the control element 3 from rotating the ball valve 2. When the pin member 4 is positioned at a second position retracted in the accommodating hole 110, the second stopper 32 abuts the extending portion 40, thereby restricting the control element 3 from rotating the ball valve 2. When the pin member 4 is positioned at the third position, the extending portion 40 corresponds to the pass groove 33, and the pass groove 33 avoids the extending portion 40 so that the control element 3 is free of restriction by the pin member 4 and is able to control the ball valve 2 to rotate. It should be noted that when the pin member 4 is at the third position and uses a rotation of the control element 3 to rotate the ball valve 2 to the open position, the extending portion 40 is located in the pass groove 33 and cannot retract into the accommodating hole 110, thereby preventing the user from rotating the fluid connector 100 without the ball valve 2 being closed.

The pin member 4 has a front portion 401 supported by the resilient member 7 and protruding forward from the accommodating hole 110 and a rear portion 402 extending rearward from the front portion 401. The diameter of the rear portion 402 is smaller than the diameter of the front portion 401. The resilient member 7 sleeves the rear portion 402 and is supported at the step 1101 between the front portion 401 and the rear portion 402. The control element 3 is a handle, and includes a base 301 located behind the protrusion 103 and an operating portion 302 extending from another end of the base 301 for pressing operation. One end of the post member 5 is fixed to the base 301 and another end of the post member 5 is fixed to the ball valve 2. The base 301 is provided with an insertion groove 3011 extending in the front-rear direction, and the insertion groove 3011 is aligned with the accommodating hole 110 in the front-rear direction to accommodate the extending portion 40. The extending portion 40 can be telescoped within the insertion groove 3011, thereby the pin member 4 can switch positions between the first position and the second position through the accommodating hole 110. The first stopper 31, the second stopper 32 and the pass groove 33 are located at one side of the insertion groove 3011, and the pass groove 33 intersects and communicates with the insertion groove 3011. Specifically, the control element 3 includes an assembly surface 30 that mates with the mounting surface 1021, and the insertion groove 30 is recessed from the assembly surface 30. The rear portion 402 includes a first section 4021 extending rearward from the front portion, a second section 4022 extending rearward from the first section 4021, and a third section 4023 extending rearward from the second section 4022. The diameters of the first and third sections are both larger than the diameter of the second section 4022, and the resilient member 7 sleeves the first section 4021. The extending portion 40 comprises the second section 4022 and the third section 4023. The control element 3 has a blocking portion 3012 located at a front end of the insertion groove 3011 to restrict the third section 4023 from moving out of the insertion groove 3011. When the pin member 4 is positioned at the first position, the third section 4023 is blocked by the first stopper 31. When the pin member 4 is positioned at the second position, the third section 4023 is blocked by the second stopper 32. When the pin member 4 is positioned at the third position, the third section 4023 is disposed in the pass groove 33, and the control element 3 is free of restriction by the pin member 4 and is able to control the ball valve 2 to rotate.

The engagement hole 501 of the matching connector 500 has a guide face. When the ball valve 2 is at the open position, pressing the operating portion 302 can make the control element 3 drive the ball valve 2 to rotate from the open position to the closed position. The extending portion 40 returns to the insertion groove 3011. Then, rotating the fluid connector 100 in the other direction, the pin member 4 can be guided by the guide face and compress the resilient member 7 to separate from the engagement hole 501. Similarly, the matching connector 500 can separate the pin member 502 through the guide face 1011 of the engagement hole 101 of the fluid connector 100 by using the above operation. Of note, the guide face facilitates guiding the pin member 4 to enter the engagement hole 501.

Of note, the fluid connector 100 of the present disclosure can engage matching connectors having different structures, as long as the matching connector has an engagement hole allowing the pin member 4 of the fluid connector 100 to be inserted and positioned at the third position, thereby unlocking the ball valve 2, and a pin member of the matching connector can be inserted into the engagement hole 101 of the fluid connector 100 for unlocking the ball valve.

1. A fluid connector comprising:
a shell having a fluid channel and an accommodating hole;
a ball valve accommodated in the shell and having a through hole;
a control element arranged outside the shell for controlling the ball valve to rotate between a closed position and an open position; and
a pin member and a resilient member both arranged in the accommodating hole; wherein
the shell has an engagement hole;
the pin member is moveable between a first position extending forward out of the accommodating hole and a second position retracted in the accommodating hole and, when the pin member is positioned at the first position or at the second position, the pin member prevents the control element from rotating the ball valve;
when the fluid connector abuts a matching connector and is rotated such that the pin member corresponds to an engagement hole of the matching connector, the pin member is pushed by the resilient member and is positioned at a third position extending into the engagement hole; and
when the pin member is positioned at the third position, the control element is free of restriction by the pin member and is able to control the ball valve to rotate.

2. The fluid connector according to claim 1, wherein when the pin member is positioned at the first position, the pin member protrudes from the accommodating hole by a first height, and when the pin member is positioned at the third position, the pin member protrudes from the accommodating hole by a second height less than the first height.

3. The fluid connector according to claim 1, wherein the pin member has an extending portion extending backward into the control element, and the control element has a first stopper, a second stopper, and a pass groove located between the first stopper and the second stopper; when the pin member is positioned at the first position or at the second position, the first stopper or the second stopper blocks the extending portion, the pin member prevents the control element from rotating the ball valve; when the pin member is positioned at the third position, the extending portion corresponds to the pass groove, the control element is free of restriction by the pin member and is able to control the ball valve to rotate.

4. The fluid connector according to claim 3, wherein when the pin member is positioned at the third position and the ball valve is rotated to the open position by the control element, the pin member is located in the pass groove and cannot be retracted in the accommodating hole.

5. The fluid connector according to claim 3, wherein the control element has an insertion groove extending in a front-rear direction for receiving the extending portion; when the ball valve is positioned at the closed position, the extending portion moves in the insertion groove to change the position of the pin member between the first position and the second position; the first stopper, the second stopper, and the pass groove are located at one side of the insertion groove, and the pass groove and the insertion groove are in fluid communication with each other.

6. The fluid connector according to claim 3, wherein the side wall of the shell has a mounting surface for mounting the control element, the front end of the shell has a protrusion protruding from the mounting surface; the accommodating hole extends through front and rear sides of the protrusion, the resilient member is received in the accommodating hole to support the pin member, and a step is provided within the accommodating hole to support the resilient member; the extending portion of the pin member extends rearward to the mounting surface.

7. The fluid connector according to claim 6, wherein the control element is connected to the ball valve through a post member, the control element comprises a base located behind the protrusion and an operating portion extending from the base, one end of the post member is fixed to the base and another end of the post member is fixed to the ball valve; the base has an insertion groove for accommodating the extending portion, the first stopper, the second stopper, and the pass groove are located at one side of the insertion groove.

8. The fluid connector according to claim 6, wherein the pin member includes a front portion and a rear portion extending rearward from the front portion, the diameter of the rear portion is smaller than the diameter of the front portion, the front section is supported by the resilient member and extends forward out of the accommodating hole.

9. The fluid connector according to claim 8, wherein the control element includes a assembly surface that mates with the mounting surface, and the insertion groove is recessed from the assembly surface; the first stopper, the second stopper, and the pass groove are located at one side of the insertion groove, and the pass groove is communicated with the insertion groove.

10. The fluid connector according to claim 9, wherein the rear portion includes a first section extending rearward from the front portion, a second section extending rearward from the first section, and a third section extending rearward from the second section; the diameters of the first and third sections are both larger than the diameter of the second section; the resilient member sleeves the first section, and the extending portion comprises the second section and the third section; the control element has a blocking portion located at a front end of the insertion groove to restrict the third section from moving out of the insertion groove; when the pin member is positioned at the first position, the third section is blocked by the first stopper; when the pin member is positioned at the second position, the third section is blocked by the second stopper; and when the pin member is positioned at the third position, the third section corresponds to the pass groove, and the control element is free of restriction by the pin member and is able to control the ball valve to rotate.

11. The fluid connector according to claim 1, wherein the matching connector has a structure similar to that of the fluid connector.

12. A fluid connector comprising:
a shell having a fluid channel and an accommodating hole;
a ball valve accommodated in the shell and having a through hole;
a control element arranged outside the shell for controlling the ball valve to rotate between a closed position and an open position; and
a pin member and a resilient member both arranged in the accommodating hole; wherein
the shell has an engagement hole;
the pin member is moveable between a first position extending forward out of the accommodating hole and a second position retracted in the accommodating hole;
when the fluid connector abuts a matching connector and is rotated such that the pin member corresponds to an engagement hole of the matching connector, the pin member is pushed by the resilient member and is positioned at a third position extending into the engagement hole;
the rear end of the pin member forms an extending portion that extends into the control element;
the control element has a stopper that blocks the extending portion and a pass groove for the extending portion to pass through;
when the pin member is positioned at the first position or at the second position, the extending portion corresponds to the stopper and the control element cannot be rotated to open the ball valve; and
when the pin member is positioned at the third position, the extending portion corresponds to the pass groove, and the control element is free of restriction by the extending portion and is able to control the ball valve to rotate.

13. The fluid connector according to claim 12, wherein the stopper includes a first stopper and a second stopper, and the pass groove is located between the first stopper and the second stopper in a front-rear direction.

14. The fluid connector according to claim 13, wherein the first stopper, the second stopper and the pass groove are located at the opposite side of an opening direction of the control element.
